(19) United States
(12) Patent Application Publication
(10) Pub. No.: US 2021/0049702 A1
(43) Pub. Date: Feb. 18, 2021

(54) RETIREMENT PLAN CREATION AND GUARANTEE

(71) Applicant: Wells Fargo Bank, N.A., San Francisco, CA (US)

(72) Inventors: Robert T. Gonci, Matthews, NC (US); Donna Edwards Peterson, Seagrove, NC (US); Stephen Francis Hudson, Fort Mill, SC (US); Daniel Paul Arendas, Mooresville, NC (US)

(21) Appl. No.: 15/797,807

(22) Filed: Oct. 30, 2017

(51) Int. Cl. G06Q 40/08

(52) U.S. Cl. CPC G06Q 40/08

(57) ABSTRACT

Various examples described herein are directed to systems and methods for creating a retirement plan and determining a guarantee. In an example, a retirement plan system is adapted to receive a plan participant's financial input and estimate retirement costs. The retirement plan system may be further adapted to determine accumulation values for the retirement plan. The retirement plan system may be further adapted to create an investment plan based on the selected accumulation value and investment requirements associated with the accumulation value. The retirement plan system may be further adapted to determine a guarantee for the investment plan.

### BACKGROUND

As many people face retirement, there are many unknowns regarding properly saving for retirement to ensure adequate retirement income. Without pensions or other annuity type vehicles, determining a person's retirement income can be complicated and uncertain. Providing a service that helps plan for retirement and offer some level of guarantee would help reduce some retirement uncertainties.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a block diagram showing creating a guarantee according to some embodiments.

FIG. 2 is a block diagram showing monitoring a plan according to some embodiments.

FIG. 3 is a flow diagram of creating a guarantee according to some embodiments.

FIG. 4 is a block diagram showing one example of a software architecture for a computing device.

FIG. 5 is a block diagram illustrating a computing device hardware architecture, within which a set or sequence of instructions can be executed to cause the hardware to perform examples of any one of the methodologies discussed herein.

### DETAILED DESCRIPTION

Determining the amount of money a person needs for retirement may be a complicated process involving different assumptions. Various saving and investing strategies may be created to help ensure a person has enough retirement income to last through their retirement. Continuing to follow such strategies may not be easy though given the normal complexities of life. Various embodiments described herein help encourage a plan participant to follow a retirement plan. For example, a plan participant may be encouraged to continue with a retirement plan based upon receiving an additional benefit or guarantee if all or part of the retirement plan is met. As a specific example, a guaranteed return on some investment for a plan participant may be provided once the plan participant follows the provided retirement plan or provided retirement advice. Automatically monitoring may be done to ensure the participant is following the retirement strategy.

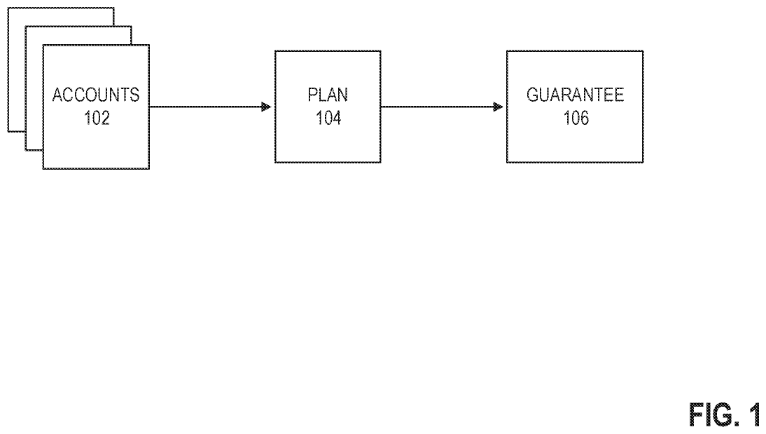

FIG. 1 is a block diagram showing creating a guarantee according to some embodiments. A person may have various accounts 102 whose assets in part or full may be used to fund the person's retirement. Accounts may include one or more of a savings account, checking account, investment account, 401K account, IRA, etc. Information associated with the accounts 102 may be stored in various data stores such as databases. The account information may be retrieved from these data stores over a network connection by a server computing device.

Additional financial inputs such as current spending, investments, 401K contributions, etc. may also be collected, stored, and used to formulate a plan 104. In an example, the plan 104 is a plan for the person's retirement. The plan may include an investment strategy that changes over time. The plan may also include an expected accrued amount based on an expected rate of return of the person's investment. The plan may also have investment requirements. The investment requirements and plan information may be stored in a database and access by various computing systems. For example, continued investing in a 401K account at a prescribed level may be a requirement. Another investment requirement may be a certain amount or a certain number of deposits into a savings or investment account.

In an example, multiple plans may be created, by a server computing system, that each have different parameters. For example, one plan may require more investment compared to other plans. Another difference may be the level of risk between the plans. The various parameters and risks involved with each plan may be provided and explained to the person.

In addition, each plan may have a guarantee 106. In an example, the guarantee 106 may be viewed as an incentive provided to the person to continue to follow the selected plan 104. The guarantee 106 may be an additional amount of money provided to the plan participant at certain points through the life of the plan 104 and/or at the end of the plan 104. For example, an amount of money may be deposited into a plan participant's 401K account for investing some amount of money during a period of time. This investment may be subject to the 401K maximums. The guarantee 106 may also be a guaranteed rate of return of certain assets; a guaranteed minimum loss; a guarantee of a percentage of principal; an additional investment amount; and/or a guarantee of the entire principal of some investments. For example, an additional investment amount may be the amount of principal that the plan participant deposits during the life of the plan, but not cover any original assets from before the start of the plan. A guarantee may be selected based upon the financial inputs and the investment requirements.

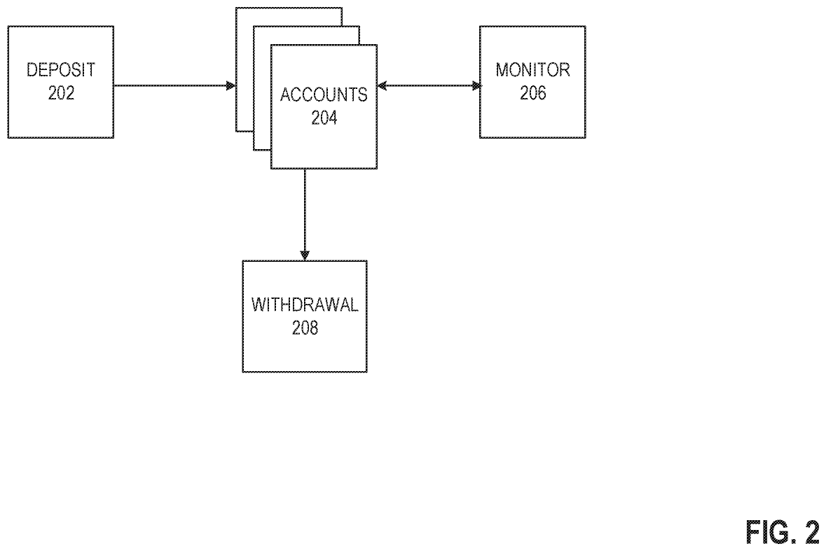

Once the plans and associated guarantees are determined, a person may elect a plan and become a plan participant. FIG. 2 is a block diagram showing monitoring a plan according to some embodiments. As part of a plan, deposits 202 may be made into one or more accounts 204. For example, the plan may have an investment requirement that a certain amount of money is deposited monthly into a 401K account or a savings account. A monitor 206 may periodically check the accounts 204 to determine if the investment requirements are being met. The monitor 206 may be a computing system that uses the plan participant's information to monitor one or more accounts associated with the plan. The monitor 206 may verify that the deposit 202 is being made. If a deposit is not being made, the monitor 206 may provide an alert to the plan participant or to a backend system. The monitor may retrieve financial data associated with a user and compare that data to stored investment requirements.

The monitor or the backend system may determine the financial impact of missing a particular deposit. In an example, the system may determine a catch-up amount of money needed to be made at a later date to account for the missed deposit. The catch-up amount is the amount needed such that the there is no adverse effect to the accumulated amount. The catch-up amount may have a time period in which the catch-up amount should be deposited, with an additional calculation for a second catch-up amount for later dates.

At a prescribed time, a plan participant may make a withdrawal 208 from the accounts 204. For example, at the of the plan the plan participant may make withdrawals 208. In a specific example, the plan participant may be retired and make withdrawals 208 as part of the plan participant's retirement income.

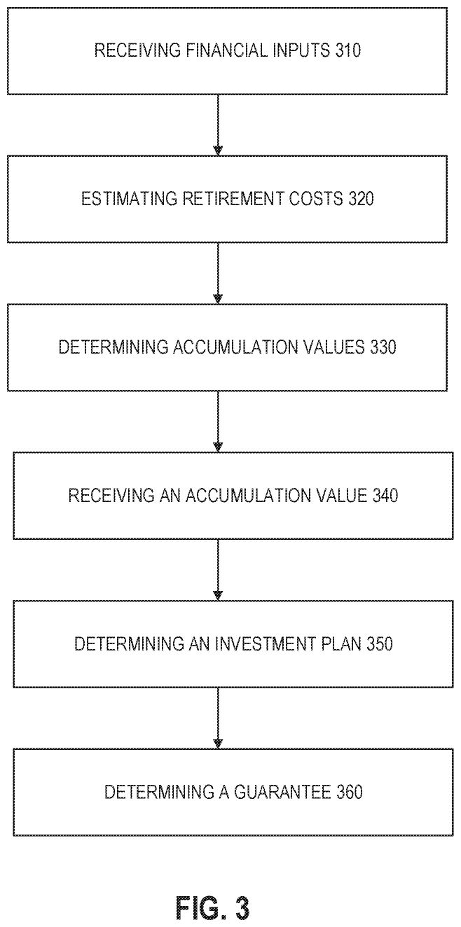

FIG. 3 is a flow diagram of creating a guarantee according to some embodiments. At 310, a plan participant's financial inputs are received. These financial inputs are used to determine a financial plan for the plan participant. The plan may be a plan for retirement, a savings goal, a debt reduction goal, etc. In an example, the plan is a retirement plan for the plan participant that is based on providing the plan participant with a predetermined amount of retirement income. Financial inputs may include exiting savings accounts, contributions to accounts, length/history of contributions, spending habits, expected when various events, such as retirement, will occur, etc.

At 320, retirement costs are estimated. Expected monthly costs may be determined as part of determining the retirement costs. A retirement locale may be determined where the plan participant may relocate to upon retirement. In addition, a housing selection may be determined. Housing selection may be based upon how large, expensive, and/or amenities that the plan participant would like in their retirement housing. Based upon the housing selection and the retirement locale, housing costs and utility costs may be calculated. Utility costs may be collected from various locales across the country and used to estimate utility costs for different locales. The utility costs may then be estimated across different locales that are of interest to the plan participant. For a retirement example, the utility costs and housing costs may be estimated across the projected length of a customer's retirement. In addition, retirement costs may include an annual increase to account for items such as inflation. Locales may also be used to estimate healthcare costs, long-term care costs, and/or taxes.

In an example, various locales and housing selections may be used to calculate various different costs that may be compared to one another. A plan participant, therefore, may see different costs for different locales. These costs may, be used to estimate the amount of retirement savings or retirement income needed for the plan participant.

At 330, accumulation values may be determined. The accumulation values may be the amount of principal the plan participant is expected to have at the end of the plan. The accumulation values may be determined based upon the financial inputs and the estimated retirement costs. In an example, the accumulation values are large enough to cover the estimated retirement costs. For example, a plan participant may be comparing one housing selection to a more modest housing selection. The retirement savings for supporting the more modest housing is less than the retirement savings for the more expensive housing. The different accumulation values are used to support either housing. To achieve a larger accumulation value, the plan participant may be required to invest more money during the plan and/or invest some assets in more risky but potentially higher upside investments. Accordingly, each accumulation value may be associated with a different investment risk. The accumulation value and the associated investment risk may be stored together in a data store for later retrieval. In addition, the accumulation value may be used to calculate a retirement income. For example, based upon the number of years of retirement, the accumulated value may be used to calculate the retirement income available on a yearly basis.

Each accumulation value may be associated with different investment requirements. An example of an investment requirement is having the plan participant continue to make deposits into an account for a certain amount of time and of certain amounts. The investment requirements may be calculated based on the financial inputs and an accumulation value. For example, a user may have little retirement savings, as indicated by the financial inputs, and desire a large accumulation value to be used for retirement. The investment requirements, therefore, would be large enough to ensure that the plan participant has the desired accumulation value at the end of the plan. Non-financial investment requirements may also be attached to an accumulated value or plan. For example, agreeing to be a member of a gym, or to visit the gym a certain number of times may be a requirement.

The various accumulation values and the investment requirements may be provided to a plan participant for review and selection. For example, the various accumulation values and the investment requirements needed to achieve the accumulation values may be provided such that the plan participant may review and compare. The various accumulation values and the investment requirements may be provided via a computing system, a mobile device, a website, etc. At 340, a selection of one of the accumulation values is received.

In an example, a probability that the selected accumulation value will be met is calculated. For example, a Monte Carlo calculation may be made to determine the probability. A security, such as an insurance policy, may be used to cover the costs and/or risk of the plan not achieving the accumulated value. This security may be purchased automatically as part of plan enrollment.

At 350, an investment plan is created based upon the selected accumulation value and the investment requirements associated with the accumulation value. In an example, the plan is created based upon determining an initial amount of assets that are to be used for saving towards the accumulation value. The difference between the accumulation value and the initial amount may be determined. The difference along with the investment requirements may then be used to determine how aggressive and how much risk is needed to achieve the accumulation value based upon the amount of time until the event, such as retirement, is reached.

The investment plan may have additional investment requirements. For example, the investment plan may require a range of different investments to ensure that assets are balanced and/or diversified according to the plan. The investment plan may also alter the original investment requirements. For example, deposits of different amounts may be used. For example, based upon the investment plan's projections less money may be needed such that the deposit amounts may be reduced.

At 360, a guarantee for the investment plan is determined. The guarantee may be based upon the selected accumulation value and the associated investment requirements. The guarantee may be one or more of a maximum guaranteed loss, reduction of fees, minimum return, guaranteed principal, etc. The guarantee may also be non-financial. For example, a guarantee may be a fixed pricing for a gym membership or discounted movie tickets. Guarantees may also change the investment requirements for an investment plan. For example, a higher guaranteed return may be provided for increasing the deposit amount that the plan participant will make. Another example is increasing the guarantee based upon requiring more money to be invested earlier in the plan to take advantage of compound interest. In the examples with various guarantees, a selected guarantee for the selected investment plan is received.

In another example, an investment plan and guarantee are determined for each of the possible accumulation values. The plan participant may then select the plan and guarantee. In this example, an investment plan may have different guarantees. For example, an investment plan may have possible guarantees of a certain lump sum at the end of the plan; smaller payments made throughout the life of the plan; and/or non-financial guarantees such as a locked in rates for services, e.g., a gym membership, etc. In another example, the investment plan may allow the user to select multiple guarantees. In this example, the selection of one guarantee may impact other guarantees. For example, the plan participant may elect to take a smaller lump stun payment at the end of the plan and select a fixed gym membership pricing during the plan.

During the plan, the investment requirements may be monitored. For example, accounts may be monitored to determine if deposits are being timely made. At the end or during the plan, the guarantee may be provided to the plan participant based upon the investment requirements being met.

While the investment requirements are being monitored by a monitor as described above, one or more investment requirements may be determined as not being met. For example, a deposit may not have been made or the deposit may be less than the required amount. The negative impact that deposit has on the plan may be determined. For example, how the deposit impacts the accumulated value may be calculated. An alert may be provided to the plan participant to let them know of the investment requirement and the negative impact it has on the accumulated value. Another example may be how the missed investment requirement impacts the guarantee of the plan. A catch-up value may be calculated. The catch-up value may be an amount of money that needs to be deposited to remedy the missed investment requirement. In this example, a deposit of the catch-up value ensures that the investment requirements are met or may be met.

In an example, monitoring an account may also allow for automatic asset allocation based upon the selected plan. For example, at certain times, such as yearly, bi-yearly, etc., investment accounts may be analyzed for the distribution of assets. The selected plan may have a requirement that the assets be allocated in a certain way. If the current distribution does not meet the requirement, asset reallocation may occur such that the asset allocation is in line with the selected plan.

Monitoring a plan participant's plan and requirements may be used to calculate a reputation score for the plan participant. The reputation score may be based on the plan participant's compliance with the various requirements. For example, the reputation score may be the number of requirements met by a customer divided by the total number of requirements to date. In an example, a requirement may be based upon the reputation score. For example, a requirement may be that the plan participant's reputation score be above a predetermine value. The reputation score may be negatively impacted when an investment requirement and/or a non-financial requirement is not met. In an example, spending habits may also be monitored and impact the reputation score. In another example, health monitoring data may be used to determine if the plan participant is meeting an exercise non-financial requirement. Additional information that may be used to impact the reputation score include the plan participant's consistent savings, credit score, sophistication of the plan, investor profile, etc. In an example, behavior across multiple plan participants may be used. For this information, a distribution of scores may be used to calculate the reputation score of a particular plan participant.

A selected plan may span multiple years. Accordingly, plan modifications may occur from time to time. As the plan changes, the associated guarantee may also change. For example, a plan participant may determine that more money will be saved for retirement. The additional funds, may provide an increase the current guarantee that was based on the previous scheduled deposits. Similarly, a plan participant may determine to save less money, in which case, the guarantee may be reduced. Changes to the plan may be made any time and/or on a pre-determined schedule.

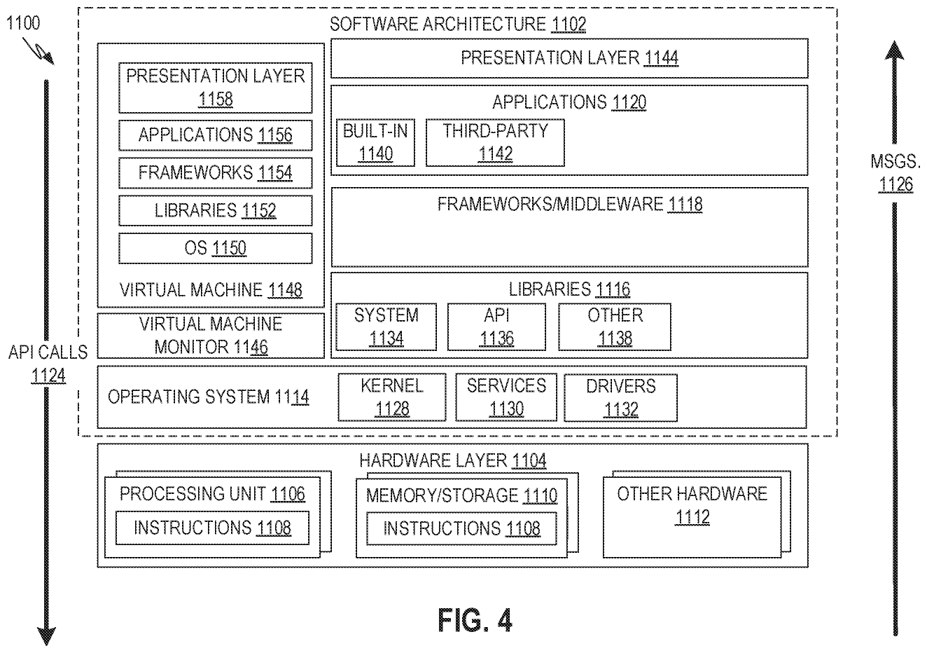

FIG. 4 is a block diagram 1100 showing one example of a software architecture 1102 for a computing device. The architecture 1102 may be used in conjunction with various hardware architectures, for example, as described herein. FIG. 4 is merely a non-limiting example of a software architecture 1102 and many other architectures may be implemented to facilitate the functionality described herein. A representative hardware layer 1104 is illustrated and can represent, for example, any of the above referenced computing devices. In some examples, the hardware layer 1104 may be implemented according to the architecture 1102 of FIG. 4.

The representative hardware layer 1104 comprises one or more processing units 1106 having associated executable instructions 1108. Executable instructions 1108 represent the executable instructions of the software architecture 1102, including implementation of the methods, modules, components, and so forth of FIGS. 1-3. Hardware layer 1104 also includes memory and/or storage modules 1110, which also have executable instructions 1108. Hardware layer 1104 may also comprise other hardware as indicated by other hardware 1112 which represents any other hardware of the hardware layer 1104, such as the other hardware illustrated as part of hardware architecture 1200.

In the example architecture of FIG. 4, the software 1102 may be conceptualized as a stack of layers where each layer provides particular functionality. For example, the software 1102 may include layers such as an operating system 1114, libraries 1116, frameworks/middleware 1118, applications 1120 and presentation layer 1144. Operationally, the applications 1120 and/or other components within the layers may invoke application programming interface (API) calls 1124 through the software stack and receive a response, returned values, and so forth illustrated as messages 1126 in response to the API calls 1124. The layers illustrated are representative in nature and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of a hardware or software interrupt and, in response, cause the architecture 1102 to pause its current processing and execute an interrupt service routine (ISR) when an interrupt s received. The ISR may generate the alert, for example, as described herein.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system 1134 libraries (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPEG4, H.264, MP3, AAC, AMR, NG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks 1118 (also sometimes referred to as middleware) may provide a higher-level common infrastructure that may be utilized by the applications 1120 and/or other software components/modules. For example, the frameworks 1118 may provide various graphic user interface (GUI) functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 includes built-in applications 1140 and/or third party applications 1142. Examples of representative built-in applications 1140 may include, but are not limited to, a contacts application, a browser application, a book reader application, a location application, a media application, a messaging application, and/or a game application. Third party applications 1142 may include any of the built in applications as well as a broad assortment of other applications. In a specific example, the third party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third party application 1142 may invoke the API calls 1124 provided by the mobile operating system such as operating system 1114 to facilitate functionality described herein.

The applications 1120 may utilize built in operating system functions (e.g., kernel 1128, services 1130 and/or drivers 1132), libraries (e.g., system 1134, APIs 1136, and other libraries 1138), frameworks/middleware 1118 to create user interfaces to interact with users of the system. Alternatively, or additionally, in some systems interactions with a user may occur through a presentation layer, such as presentation layer 1144. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 4, this is illustrated by virtual machine 1148. A virtual machine creates a software environment where applications/modules can execute as if they were executing on a hardware computing device. A virtual machine is hosted by a host operating system (operating system 1114) and typically, although not always, has a virtual machine monitor 1146, which manages the operation of the virtual machine as well as the interface with the host operating system (i.e., operating system 1114). A software architecture executes within the virtual machine such as an operating system 1150, libraries 1152, frameworks/middleware 1154, applications 1156 and/or presentation layer 1158. These layers of software architecture executing within the virtual machine 1148 can be the same as corresponding layers previously described or may be different.

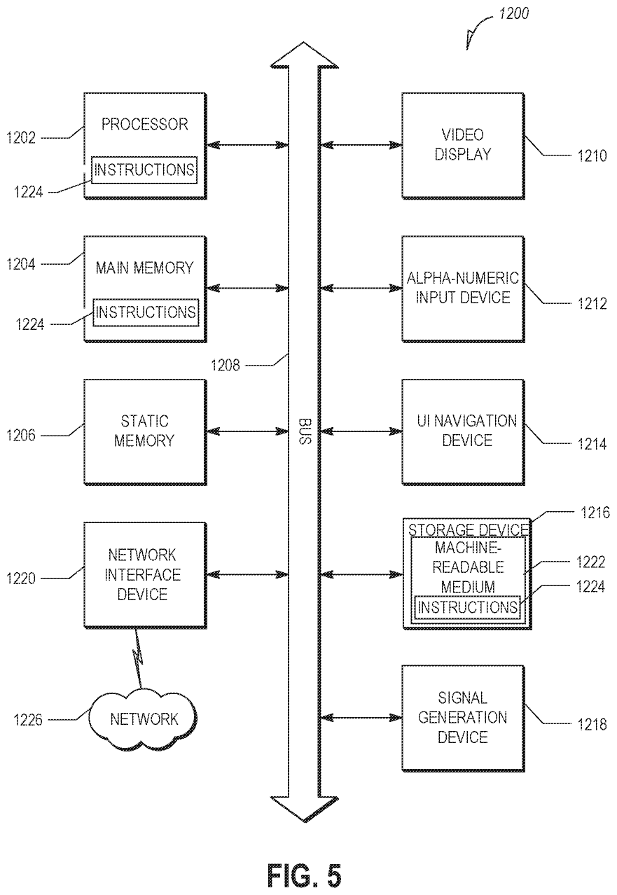

FIG. 5 is a block diagram illustrating a computing device hardware architecture 1200, within which a set or sequence of instructions can be executed to cause the machine to perform examples of any one of the methodologies discussed herein. For example, the architecture 1200 may execute the software architecture 1102 described with respect to FIG. 4. The architecture 1200 may operate as a standalone device or may be connected (e.g., networked) to other machines. In a networked deployment, the architecture 1200 may operate in the capacity of either a server or a client machine in server-client network environments, or it may act as a peer machine in peer-to-peer (or distributed) network environments. The architecture 1200 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 1200 includes a processor unit 1202 comprising at least one processor (e.g., a central processing unit (CPU), a graphics processing unit (GPU) or both, processor cores, compute nodes, etc.). The architecture 1200 may further comprise a main memory 1204 and a static memory 1206, which communicate with each other via a link 1208 (e.g., bus). The architecture 1200 can further include a video display unit 1210, an alphanumeric input device 1212 (e.g., a keyboard), and a user interface (UI) navigation device 1214 (e.g., a mouse) in some examples, the video display unit 1210, input device 1212 and UI navigation device 1214 are incorporated into a touch screen display. The architecture 1200 may additionally include a storage device 1216 (e.g., a drive unit), a signal generation device 1218 (e.g., a speaker), a network interface device 1220, and one or more sensors (not shown), such as a global positioning system (GPS) sensor, compass, accelerometer, or other sensor.

In some examples, the processor unit 1202 or other suitable hardware component may support a hardware interrupt. In response to a hardware interrupt, the processor unit 1202 may pause its processing and execute an interrupt service routine (ISR), for example, as described herein.

The storage device 1216 includes a machine-readable medium 1222 on which is stored one or more sets of data structures and instructions 1224 (e.g., software) embodying or utilized by any one or more of the methodologies or functions described herein. The instructions 1224 can also reside, completely or at least partially, within the main memory 1204, static memory 1206, and/or within the processor 1202 during execution thereof by the architecture 1200, with the main memory 1204, static memory 1206, and the processor 1202 also constituting machine-readable media. Instructions stored at the machine-readable medium 1222 may include, for example, instructions for implementing the software architecture 1102, instructions for executing any of the features described herein, etc.

While the machine-readable medium 1222 is illustrated in an example to be a single medium, the term “machine-readable medium” can include a single medium or multiple media (e.g., a centralized or distributed database, and/or associated caches and servers) that store the one or more instructions 1224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1224 can further be transmitted or received over a communications network 1226 using a transmission medium via the network interface device 1220 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method comprising:
receiving, by a server computing device via a network connection, financial inputs associated with a retirement for a user;
estimating, by the server computing device, retirement costs for the retirement;
determining, by the server computing device, a plurality of accumulation values based upon the financial inputs and the estimated retirement costs, each accumulation value having a different investment risk;
receiving, by the server computing device, a selection of a selected accumulation value from the plurality of accumulation values;
determining, by the server computing device, an investment plan for the selected accumulation value, wherein the investment plan includes a financial requirement and a non-financial requirement;
receiving an indication of performance of the non-financial requirement by the user; and
adjusting the selected accumulation value based on the indication of the performance of the non-financial requirement.

2. The method of claim 1, further comprising:
comparing data values to values associated with the financial requirement and the non-financial requirement that are stored in a database;
determining the financial requirement and the non-financial requirement have been met based upon the comparing data values to the values associated with the financial requirement and the non-financial requirement.

3. The method of claim 1, wherein the estimating retirement costs comprises:
receiving a geographic retirement location;
receiving a retirement housing selection; and
estimating utility costs based on the retirement location and retirement housing selection.

4. The method of claim 1, further comprising:
determining the financial requirement has not been met;
calculating a negative impact on the selected accumulation value based upon a unmet financial requirement; and
providing an alert comprising the negative impact.

5. The method of claim 4, further comprising calculating a catch-up value based upon the unmet financial requirement.

6. (canceled)

7. The method of claim 1, further comprising identifying a financial guarantee that is an investment principal.

8. The method of claim 1, further comprising identifying a financial guarantee that is an additional investment amount.

9. The method of claim 1, further comprising determining a retirement income amount based upon the selected accumulated value.

10. The method of claim 1, further comprising calculating a reputation score based upon met requirements from the financial requirement and the non-financial requirement.

11. The method of claim 1, further comprising:
determining a plurality of non-investment requirements; and
determining the plurality of non-investment requirements have been met.

12. The method of claim 11, further comprising providing an incentive based upon a non-investment requirement having been met.

13. The method of claim 12, the incentive comprising a discount to a gym membership.

14. The method of claim 1, wherein the determining the financial requirement has been met comprises monitoring an investment account for deposits.

15. A system comprising:
one or more electronic processors to execute operations comprising:
receiving financial inputs associated with a retirement of a user;
estimating retirement costs for the retirement;
determining a plurality of accumulation values based upon the financial inputs and the estimated retirement costs, each accumulation value having a different investment risk;
receiving a selection of a selected accumulation value from the plurality of accumulation values;
determining an investment plan for the selected accumulation value, wherein the investment plan includes a financial requirement and a non-financial requirement;
receiving an indication of performance of the non-financial requirement by the user; and
adjusting the selected accumulation value based on the indication of the performance of the non-financial requirement.

16. The system of claim 15, wherein the estimating retirement costs comprises:
receiving a geographic retirement location;
receiving a retirement housing selection; and
estimating utility costs based on the retirement location and retirement housing selection.

17. The system of claim 15, wherein the operations further comprise:
determining the financial requirement has not been met;
calculating a negative impact on the selected accumulation value based upon a unmet financial requirement; and
providing an alert comprising the negative impact.

18. The system of claim 17, wherein the operations further comprise calculating a catch-up value based upon the unmet financial requirement.

19. A non-transitory machine-readable medium comprising instructions thereon that, when executed by at least one processor unit, causes the at least one processor unit to perform operations comprising:
receiving financial inputs associated with a retirement of a user;
estimating retirement costs for the retirement;
determining a plurality of accumulation values based upon the financial inputs and the estimated retirement costs, each accumulation value having a different investment risk;
receiving a selection of a selected accumulation value from the plurality of accumulation values;
determining an investment plan for the selected accumulation value, wherein the investment plan includes a financial requirement and a non-financial requirement;
receiving an indication of performance of the non-financial requirement by the user; and
adjusting the selected accumulation value based on the indication of the performance of the non-financial requirement.

20. The non-transitory machine-readable medium of claim 19, wherein the estimating retirement costs comprises:
receiving a geographic retirement location;
receiving a retirement housing selection; and
estimating utility costs based on the retirement location and retirement housing selection.

21. (canceled)

22. The non-transitory machine-readable medium of claim 19, further performing operations comprising:
determining the financial requirement has not been met;
calculating a negative impact on the selected accumulation value based upon a unmet financial requirement; and
providing an alert comprising the negative impact.
